(19) United States
(12) Patent Application Publication
(10) Pub. No.: US 2024/0328188 A1
(43) Pub. Date: Oct. 3, 2024

(54) Pivoting Wind Turbine Tower Assembly

(71) Applicant: Emil Ellenbogen, Brooklyn, NY (US)

(72) Inventor: Emil Ellenbogen, Brooklyn, NY (US)

(21) Appl. No.: 18/385,315

(22) Filed: Oct. 30, 2023

Related U.S. Application Data
(60) Provisional application No. 63/493,960, filed on Apr. 3, 2023.
(60) Provisional application No. 63/494,476, filed on Apr. 6, 2023.
(60) Provisional application No. 63/495,109, filed on Apr. 9, 2023.
(60) Provisional application No. 63/499,341, filed on May 1, 2023.

(51) Int. Cl. E04H 12/18; F03D 13/20

(52) U.S. Cl. CPC E04H 12/18; F03D 13/201; F05B 2240/912

(57) ABSTRACT

A pivoting wind turbine tower assembly includes at least one wind turbine, at least one base structure, and at least one lifting mechanism. The lifting mechanism includes a mounting shaft, a pivoting arm, a counterweight, a winch, and a cable. The mounting shaft is outwardly connected to the base structure. The pivoting arm is rotatably mounted to the mounting shaft. The wind turbine is terminally mounted to a first end of the pivoting arm. The counterweight is terminally mounted to a second end of the pivoting arm. The winch is mounted offset to the counterweight as the cable is tensionably connected between the counterweight and the winch. Resultantly, the rotational direction of the winch is able to move the orientation of the pivoting arm so that the wind turbine can be configured into a lowered position and a raised position about the mounting shaft.

The current application claims a priority to the U.S. provisional patent application Ser. No. 63/493,960 filed on Apr. 3, 2023.

The current application also claims a priority to the U.S. provisional patent application Ser. No. 63/494,476 filed on Apr. 6, 2023.

The current application also claims a priority to the U.S. provisional patent application Ser. No. 63/495,109 filed on Apr. 9, 2023.

The current application also claims a priority to the U.S. provisional patent application Ser. No. 63/499,341 filed on May 1, 2023.

### FIELD OF THE INVENTION

The present invention generally relates to a pivoting wind turbine tower assembly that can be mounted to existing structures or a tower base. More specifically, the present invention allows the wind turbine to be rotated in between a lowered position and a raised position to lower capital expenditure and operational cost.

### BACKGROUND OF THE INVENTION

As technology and industry in the modern world continues to grow and expand, so do the power requirements. Many different sources of power generation exist today involving fossil fuel burning, solar, wind, geothermal, hydroelectric, wave and current power generation, etc. Wind turbines are a renewable energy source that converts the kinetic energy of wind into electrical energy. Wind turbines are generally installed as a wind farm and can generate a large amount of power. Wind turbines are an increasingly important source of intermittent renewable energy and used in many countries to lower energy costs and reduce reliance on fossil fuels. Wind turbines are manufactured in a wide range of sizes, with either horizontal or vertical axes, though horizontal is most common. Generally, a tower is built and then the wind turbine nacelle and their blades are lifted onto the tower using a high lift capacity crane. The assembly process of a wind turbine is expensive due to the operating charges of the high lift capacity cranes. Furthermore, when repairs need to be done to the blades, the high lift capacity cranes are utilized to disassemble nacelle or the blades accumulating additional expenses. Furthermore, high altitude of the wind turbines creates challenging and hazardous environments for assembly crews and maintenance crews.

It is therefore an objective of the present invention to provide a pivoting wind turbine tower assembly so that the nacelle and the blades can be lowered when necessary. The present invention is rotatably mounted to existing buildings or a tower base and uses a lifting mechanism to lower and raise the wind turbine. Due to the pivoting feature, the present invention allows the assembly crews and the maintenance crews to bypass the usage of the high lift capacity cranes. As a result, the present invention is able to lower the capital expenditure and operational costs of the wind turbines and creates a safe environment for the assembly crews and maintenance crews. Additionally, the present invention may be used on ships to either mechanically power the ships or electrically charge the ship's batteries.

### BRIEF DESCRIPTION OF THE DRAWINGS

FIG. 1 is a front view of the present invention, showing the raised position.

FIG. 2 is a side view of the present invention, showing the raised position.

FIG. 3 is a front view of the present invention, showing the movement from the raised position to the lowered position.

FIG. 4 is a side view of the present invention, showing the movement from the raised position to the lowered position.

FIG. 5 is a front view of the present invention, showing the lowered position.

FIG. 6 is a side view of the present invention, showing the lowered position.

FIG. 7 is a side view of the present invention, wherein the pivot mechanism positions the wind turbine perpendicular to the ground surface.

FIG. 8 is a side view of the present invention, wherein the pivot mechanism positions the wind turbine parallel to the ground surface.

FIG. 9 is a schematic view showing the wind turbine of the present invention.

FIG. 10 is a schematic view showing the first alternative configuration of the present invention.

FIG. 11 is a schematic view showing the second alternative configuration of the present invention.

FIG. 12 is a side view of the present invention, showing the raised position as the present invention is mounted to an exoskeleton structure.

### DETAILED DESCRIPTION OF THE INVENTION

All illustrations of the drawings are for the purpose of describing selected versions of the present invention and are not intended to limit the scope of the present invention.

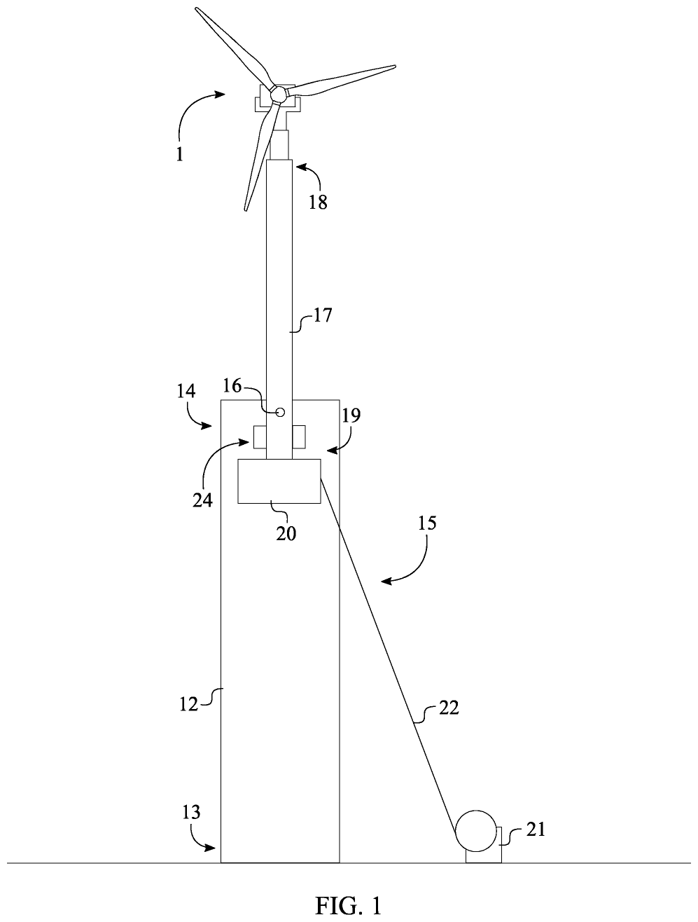

The present invention is a pivoting wind turbine tower assembly that reduces maintenance costs and maintenance time without compromising the efficiency. The present invention can be mounted to an existing structure such as buildings or a tower base that need to be constructed. The rest of the components of the present invention are pivoted upward about the existing structure or the tower base, increasing the operational height of the present invention, so that the kinetic energy of the wind can be transferred into electrical energy. As shown in FIG. 1, the present invention comprises at least one wind turbine 1, at least one base structure 12, and at least one lifting mechanism 15.

In reference to the general configuration of the present invention, as shown in FIGS. 1-6, the existing structure or the tower base functions as the base structure 12 so that the wind turbine 1 can be rotatably mounted to the base structure 12 by the lifting mechanism 15. Furthermore, the lifting mechanism 15 enables the wind turbine 1 to be configured into a lowered position and a raised position. When the present invention is at the lowered position, the maintenance crews can easily access the wind turbine 1 to complete necessary repairs or routine maintenance without needing a high lift capacity crane. When the present invention is at the raised position, the wind turbine 1 is able to harness the kinetic energy of the wind to generate electrical energy. Furthermore, ships or any other types of floating structures can also function as the base structure 12 thus allowing the present invention to harness wind energy.

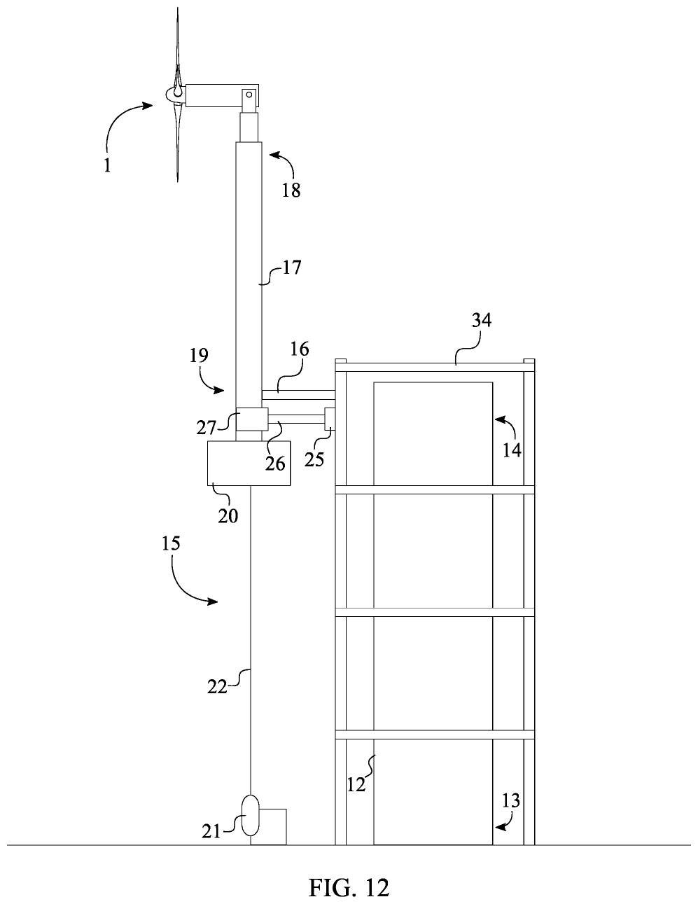

In reference to FIGS. 1-6, the base structure 12 is preferably the existing structure such as high-rise buildings, water tanks, towers, or any other types of high-rise structures. The base structure 12 may comprise a fixed end 13 and a free end 14, wherein the fixed end 13 and the free end 14 are oppositely positioned of each other. The fixed end 13 is connected to the ground surface, and the free end 14 is the opposite end that defines the height of the base structure 12. In order to mount the wind turbine 1 and the lifting mechanism 15, the base structure 12 may have to be reinforced according to the system specification. Furthermore, an exoskeleton structure 34 can be utilized to mount the wind turbine 1 and the lifting mechanism 15 when the base structure 12 lacks the proper support and strength to withstand the weight and the movement of the present invention, wherein the exoskeleton structure 34 is built, anchored, and positioned around the base structure 12 as shown in FIG. 12.

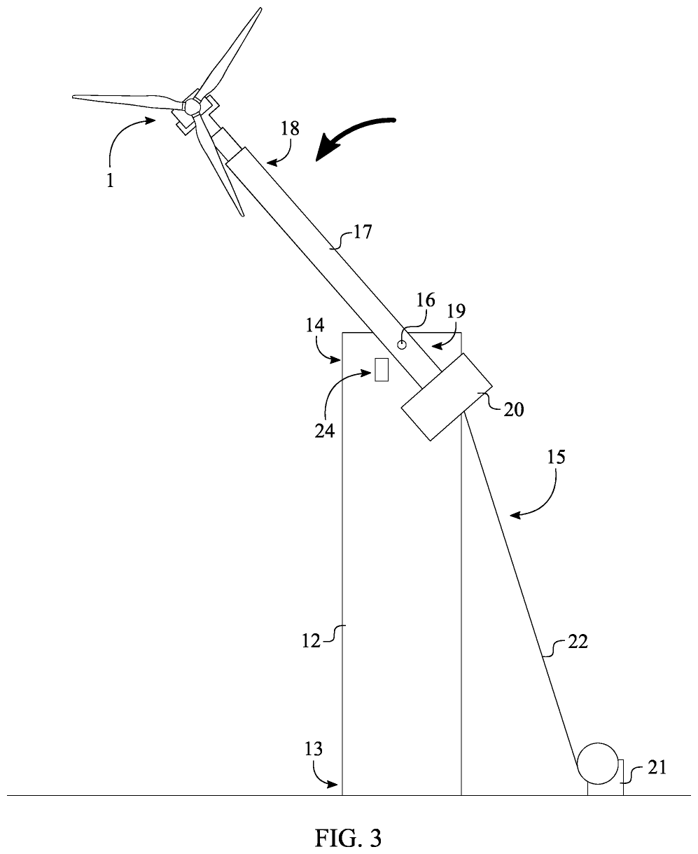

In reference to FIGS. 1-6, the lifting mechanism 15 may comprise a mounting shaft 16, a pivoting arm 17, a counterweight 20, a winch 21, and a cable 22 so that the wind turbine 1 can be lifted or lowered. More specifically, the mounting shaft 16 is outwardly connected to the base structure 12. Preferably, the mounting shaft 16 is positioned adjacent to the free end 14 of the base structure 12 to maximize the height of the wind turbine 1. Resultantly, the mounting shaft 16 extends horizontally from base structure 12 and functions as a structural member so that the pivoting arm 17 can be rotationally mounted. The pivoting arm 17 functions as a tubular extension between the mounting shaft 16 and the wind turbine 1. The pivoting arm 17 is rotatably mounted to the mounting shaft 16 in such a way that the second end 19 of the pivoting arm 17 is positioned adjacent to the free end 14 of the base structure 12. More specifically, the wind turbine 1 is terminally mounted to a first end 18 of the pivoting arm 17. The counterweight 20 is terminally mounted to a second end 19 of the pivoting arm 17 so that the counterweight 20 is able to balance the total weight of the wind turbine 1. The winch 21 is mounted offset to the counterweight 20 and preferably positioned about the ground surface. The cable 22 is tensionably connected between the counterweight 20 and the winch 21 so that the rotational direction of the winch 21 can move the wind turbine 1 into the lowered position and the raised position about the mounting shaft 16. In other words, the winch 21 is positioned adjacent to the fixed end 13 of the base structure 12 and positioned offset from the mounting shaft 16 so that the cable 22 can be angularly positioned in between the counterweight 20 and the winch 21. Resultantly, the reeling of the cable 22 is able to rotate the pivoting arm 17 in one direction, and the releasing of the cable 22 is able to rotate the pivoting arm 17 in opposite direction. For example, the reeling of the cable 22 can rotate the pivoting arm 17 in clockwise direction about the mounting shaft 16, and the releasing of the cable 22 can rotate the pivoting arm 17 in counterclockwise direction about the mounting shaft 16 as shown in FIG. 3. The counterweight 20 can be a weighted structure or a hallow structure that can be filled with water or any other material. When the counterweight 20 is filled with water, the stored quantity of water can be utilized as drinking water or to extinguish fire. Even though the lifting mechanism 15 is explained in relation to the abovementioned components, the lifting mechanism can comprise other type of rotational mechanical system such as electric motors or hydraulic motors and other relevant components such as gear systems, pully systems, and fastening systems so that the pivoting arm 17 can be rotated about the base structure 12.

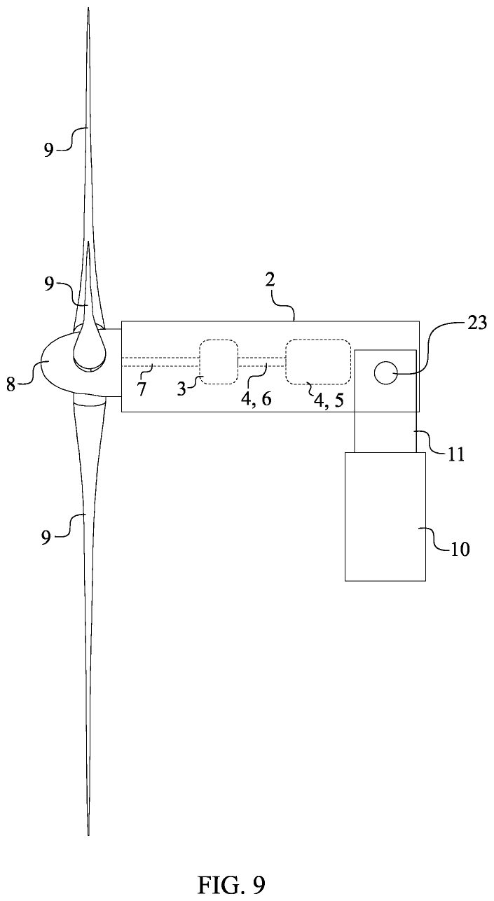

In reference to FIG. 9, the wind turbine 1 may comprise a nacelle 2, a gearbox 3, a generator 4, a main shaft 7, a hub 8, a plurality of blades 9, a yaw drive unit 10, and a yaw drive extension 11 so that kinetic energy of the wind can be converted to electrical energy. The gearbox 3, the generator 4, and the main shaft 7 are positioned within the nacelle 2 to protect from outside elements such as rain. The hub 8 is externally positioned to the nacelle 2 and provides a surface area to mount the plurality of blades 9. A stator 5 of the generator 4 is mounted to the nacelle 2, and the gearbox 3 is mounted to the nacelle 2. A rotor 6 of the generator 4 is rotatably connected to the main shaft 7 through the gearbox 3 and positioned within the nacelle 2 thus allowing the hub 8 to be axially connected to the main shaft 7. Each of the plurality of blades 9 is radially connected to the hub 8. As a result, the plurality of blades 9 is able to harness the kinetic energy of the wind thus rotating hub 8, the main shaft 7, the gearbox 3, and the rotor 6. Then, the generator 4 is able to convert the kinetic energy of the wind into electrical energy. The nacelle 2 is mounted to the first end 18 of the pivoting arm 17 by the yaw drive unit 10 and the yaw drive extension 11. More specifically, the yaw drive unit 10 is mounted to the first end 18 of the pivoting arm 17 and optimizes the positioning of the wind turbine 1 against the direction of wind for maximum power generation. The yaw drive extension 11 provides sufficient clearance between the nacelle 2 and the first end 18 of the pivoting arm 17. Furthermore, the yaw drive extension 11 is operatively coupled with the yaw drive unit 10 thus allowing the rotational movement of the yaw drive unit 10 to be transferred to the yaw drive extension 11.

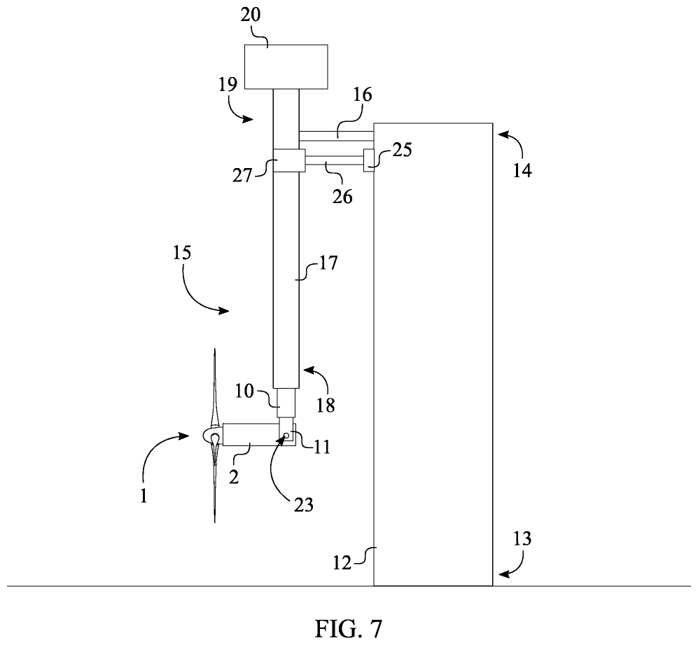

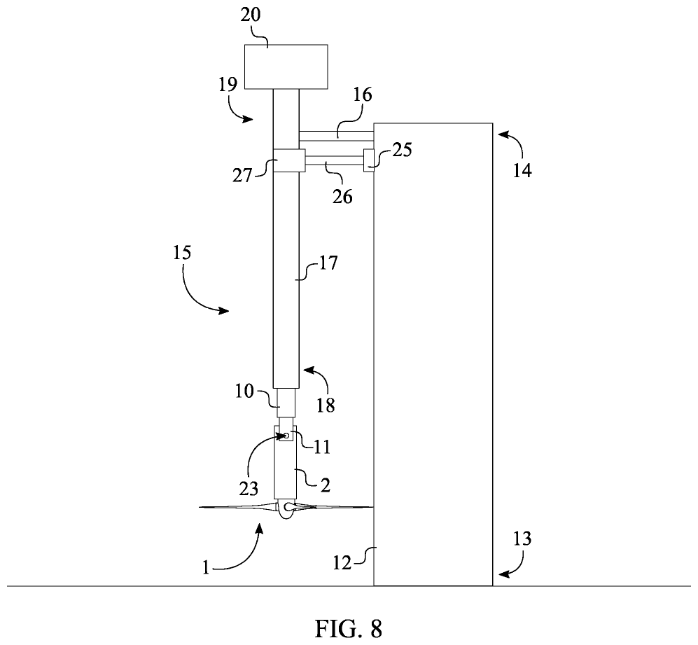

In reference to FIG. 7 and FIG. 8, the present invention may further comprise a rotary adjustment mechanism 23 so that the nacelle 2 can be rotated 0 to 90 degrees. The nacelle 2 is rotatably mounted to the yaw drive extension 11 by the rotary adjustment mechanism 23 as the rotary adjustment mechanism 23 is able to angularly change the positioning of the wind turbine 1. The rotary adjustment mechanism 23 can be a hydraulic motor, a gear box, an electric motor, or any other similar mechanical system that can change the annular positioning of the nacelle 2 in relation to the pivoting arm 17. More specifically, when the present invention is at the lowered position, the rotary adjustment mechanism 23 can orient the plurality of blades 9 parallel to the ground surface or perpendicular to the ground surface due to the fact that the rotary adjustment mechanism 23 can rotate the nacelle 2 from 0 to 90 degrees. Resultantly, the removing, repairing, and mounting process of the plurality of blades 9 can be easily completed when the pivoting arm 17 is at the lowered position, and the plurality of blades 9 is positioned parallel to the ground surface. When the pivoting arm 17 is ready to be rotated to the raised position, the nacelle 2 is rotated 90 degrees so that the plurality of blades 9 can be oriented perpendicular to the ground surface.

Additionally, the yaw drive unit 10 and the rotary adjustment mechanism 23 can be integrated into a single mechanical system within the present invention without deviating from the intended scope and the functionality of the each of the corresponding components.

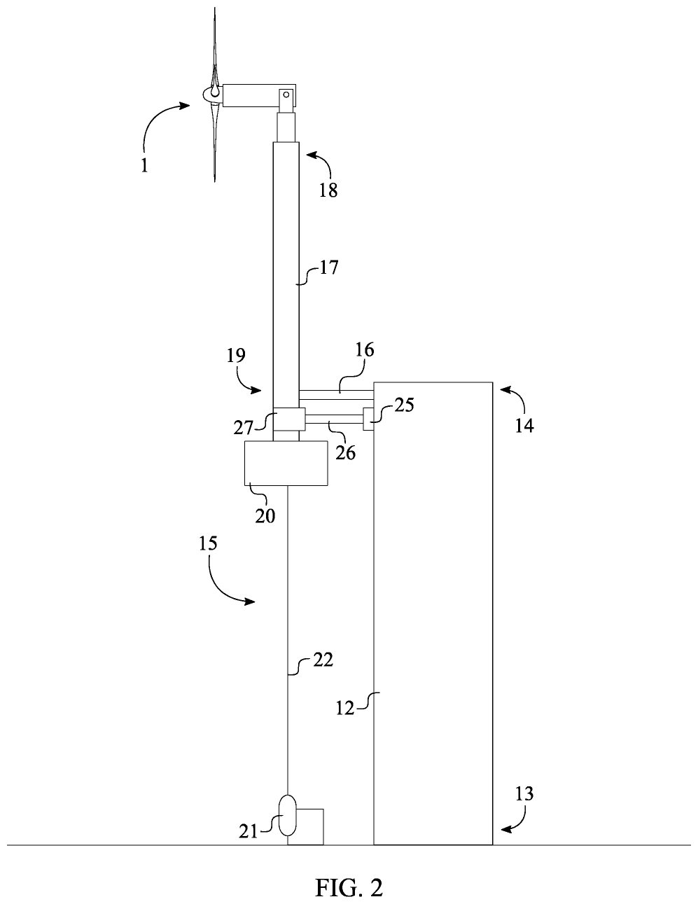

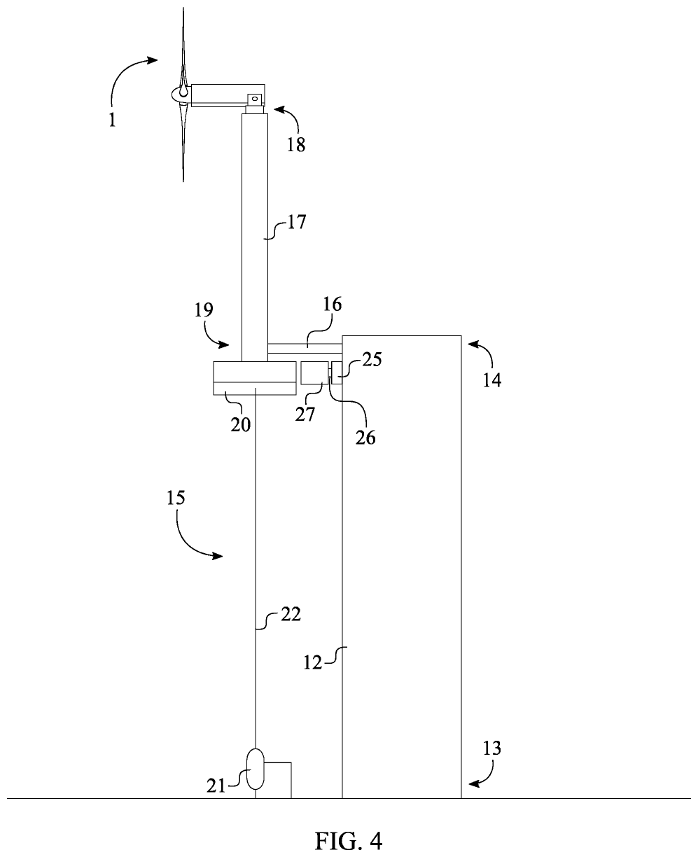

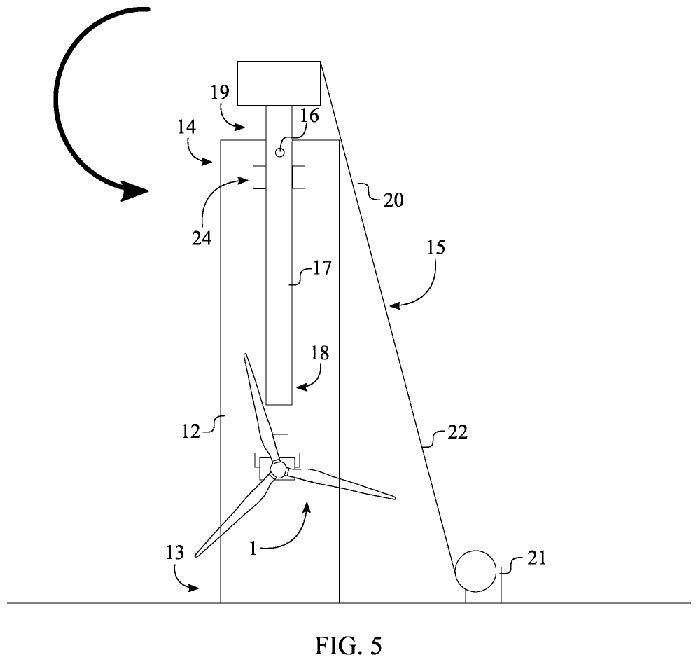

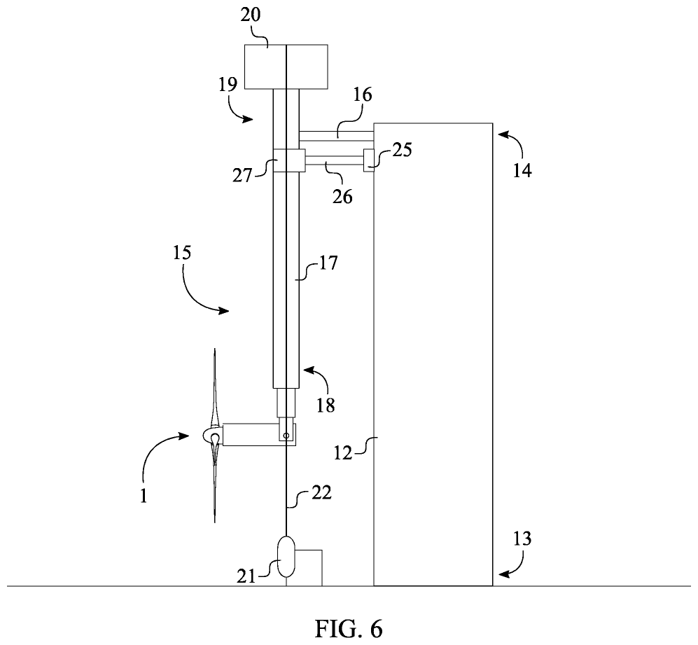

The present invention may further comprise at least one locking mechanism 24 to further strengthen the positioning of the pivoting arm 17. In reference to FIG. 2, FIG. 4, and FIG. 6, the locking mechanism 24 may comprise a support 25, an actuator 26, and a locking body 27. The support 25 is laterally mounted to the base structure 12 and functions as a stationary body. For example, the support 25 can be a motorized unit that is mounted to the base structure 12 or any other industry standard mechanical device that can activate the actuator 26. The actuator 26 is integrated into the support 25 as the locking body 27 is connected to the actuator 26. For example, the actuator 26 can be a piston rod that can engage and disengage the locking body 27 or any other industry standard mechanical device that can achieve physical movement. In other words, the locking body 27 is controlled by the actuator 26 so that the locking body 27 can selectively engage with the pivoting arm 17. For example, the locking body 27 can be a pair of locking-clamps or any other type of fastening unit that can lock the positioning of the pivoting arm 17. When the present invention is at the lowered position, the locking body 27 engages with the pivoting arm 17 to eliminate unnecessary lateral movements. Similarly, when the present invention is at the raised position, the locking body 27 engages with the pivoting arm 17 to eliminate unnecessary lateral movements. Furthermore, when the pivoting arm 17 needs to be rotated from the raised position to the lowered position or vice versa, the locking body 27 is disengaged from the pivoting arm 17. Furthermore, the pivoting arm 17 can also be secured in any angular positioning in between the raised position and the lowered position via the locking mechanism 24 to perform necessary repairs or maintenance. Furthermore, the present invention can harness wind energy at any angular positioning in between the raised position and the lowered position as the locking mechanism 24 is able to firmly secure the pivoting arm 17. For example, the wind turbine 1 can be operational when the pivoting arm 17 is perpendicularly positioned to the base structure 12. In reference to FIG. 5, when the present invention is at the lowered position, the counterweight 20 is positioned atop the free end 14 of the base structure 12. The wind turbine 1 is positioned adjacent to the fixed end 13 of the base structure 12. Resultantly, the lowered position of the present invention allows the wind turbine 1 to be assembled, protected from adverse weather conditions, or serviced.

In reference to FIG. 1, when the present invention is at the raised position, the wind turbine 1 is positioned atop the free end 14 of the base structure 12. The counterweight 20 is positioned adjacent to the free end 14 of the base structure 12. Resultantly, the raised position of the present invention allows the wind turbine 1 to be operational.

A preferred configuration of the present invention is shown within FIGS. 1-6 as the at least one wind turbine 1 may comprise a first turbine 30, and the at least one base structure 12 may comprise a first base 32. Then, the lifting mechanism 15 is able to mount and rotatably position the first turbine 30 with respect to the first base 32.

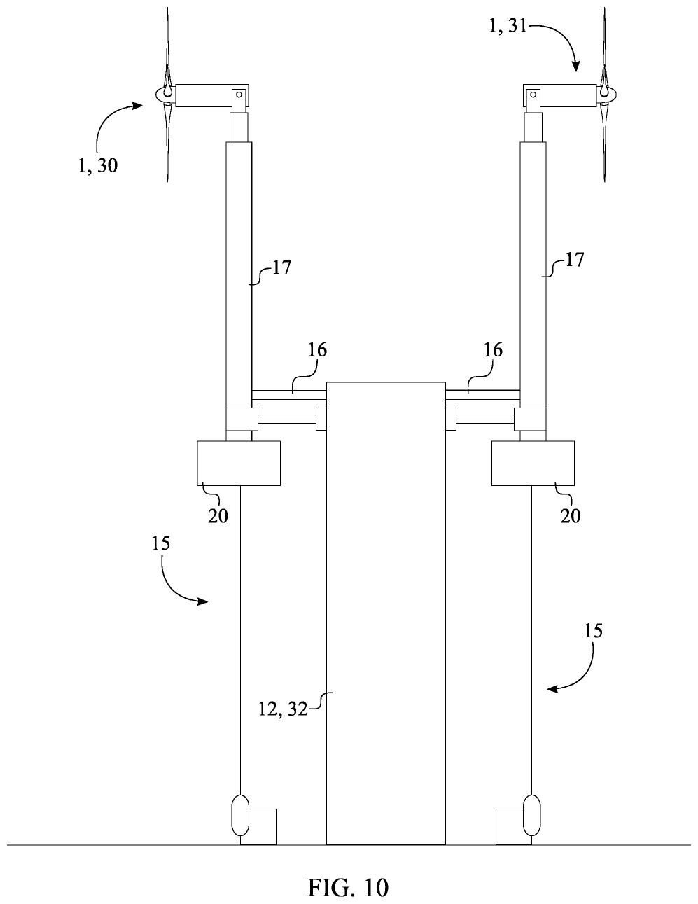

A first alternative configuration of the present invention is shown within FIG. 10 as the at least one wind turbine 1 may comprise the first turbine 30 and a second turbine 31, and the at least one base structure 12 may comprise the first base 32. Then, the lifting mechanism 15 is able to mount and rotatably position the first turbine 30 and the second turbine 31 with respect to the first base 32. More specifically, the first turbine 30 and the second turbine 31 are oppositely positioned of each other about the first base 32 as the first turbine 30 and the second turbine 31 are mounted to the first base 32 by the lifting mechanism 15.

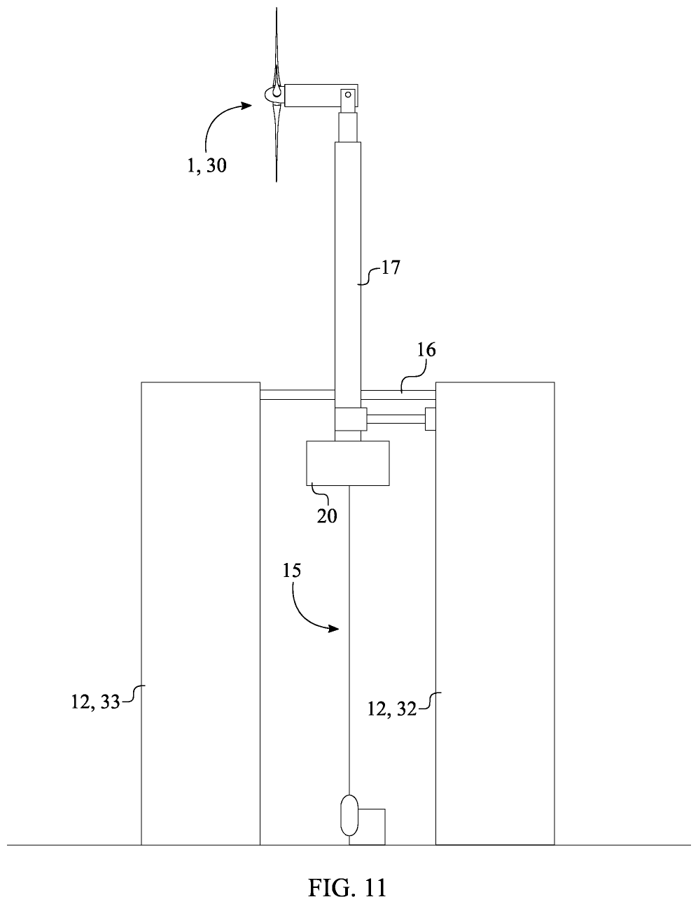

A second alternative configuration of the present invention is shown within FIG. 11 as the at least one wind turbine 1 may comprise the first turbine 30, and the at least one base structure 12 may comprise the first base 32 and a second base 33. Then, the lifting mechanism 15 is able to mount and rotatably position the first turbine 30 with respect to the first base 32 and the second base 33. More specifically, the first base 32 and the second base 33 are oppositely positioned of each other about the first turbine 30 as the first turbine 30 is mounted to the first base 32 and the second base 33 by the lifting mechanism 15.

Additionally, the present invention may further comprise a secondary counterweight so that the weight of the wind turbine 1, the lifting mechanism 15, the rotary adjustment mechanism 23, the locking mechanism 24 can be balanced about the base structure 12. More specifically, the secondary counterweight is mounted to the base structure 12 as the wind turbine 1, the lifting mechanism 15, the rotary adjustment mechanism 23, and the locking mechanism 24 are oppositely positioned from and the secondary counterweight about the base structure 12.

Although the invention has been explained in relation to its preferred embodiment, it is to be understood that many other possible modifications and variations can be made without departing from the spirit and scope of the invention as hereinafter claimed.

1. A pivoting wind turbine tower assembly comprising:
at least one wind turbine;
at least one base structure;
at least one lifting mechanism;
the lifting mechanism comprising a mounting shaft, a pivoting arm, a counterweight, a winch, and a cable;
the mounting shaft being outwardly connected to the base structure;
the pivoting arm being rotatably mounted to the mounting shaft;
the wind turbine being mounted onto a first end of the pivoting arm;
the counterweight being mounted onto a second end of the pivoting arm;
the winch being mounted offset to the counterweight; and
the cable being tensionably connected between the counterweight and the winch, wherein the rotational direction of the winch moves the wind turbine between a lowered position and a raised position about the mounting shaft.

2. The pivoting wind turbine tower assembly as claimed in claim 1 comprising:
the base structure comprising a fixed end and a free end;
the fixed end and the free end being oppositely positioned of each other;
the mounting shaft being positioned adjacent to the free end; and
the second end of the pivoting arm being positioned adjacent to the free end.

3. The pivoting wind turbine tower assembly as claimed in claim 1 comprising:
the wind turbine comprising a nacelle, a gearbox, a generator, a main shaft, a hub, a plurality of blades, a yaw drive unit, and a yaw drive extension;
the gearbox, the generator, and the main shaft being positioned within the nacelle;
the hub being externally positioned to the nacelle;
a stator of the generator being mounted to the nacelle;
the gearbox being mounted to the nacelle;
a rotor of the generator being rotatably connected to the main shaft through the gearbox;
the hub being axially connected to the main shaft;
each of the plurality of blades being radially connected to the hub; and
the nacelle being mounted to the first end of the pivoting arm by the yaw drive unit and the yaw drive extension.

4. The pivoting wind turbine tower assembly as claimed in claim 3 comprising:
a rotary adjustment mechanism;
the yaw drive extension being operatively coupled with the yaw drive unit, wherein rotational movement of the yaw drive unit is transferred to the yaw drive extension;
the yaw drive unit being mounted to the first end of the pivoting arm; and
the nacelle being operatively coupled with the yaw drive extension by the rotary adjustment mechanism, wherein the rotary adjustment mechanism changes the annular positioning of the nacelle in relation to the pivoting arm.

5. The pivoting wind turbine tower assembly as claimed in claim 4, wherein the rotary adjustment mechanism rotates the nacelle 0 to 90 degrees.

6. The pivoting wind turbine tower assembly as claimed in claim 1 comprising:
the winch being positioned adjacent to a fixed end of the base structure; and
the winch being positioned offset from the mounting shaft.

7. The pivoting wind turbine tower assembly as claimed in claim 1 comprising:
at least one locking mechanism;
the locking mechanism comprising a support, an actuator, and a locking body;
the support being laterally mounted to the base structure;
the actuator being integrated into the support;
the locking body being connected to the actuator; and
the locking body being selectively engaged with the pivoting arm.

8. The pivoting wind turbine tower assembly as claimed in claim 1 comprising:
wherein the wind turbine is in the lowered position;
the counterweight being positioned atop a free end of the base structure; and
the wind turbine being positioned adjacent to a fixed end of the base structure.

9. The pivoting wind turbine tower assembly as claimed in claim 1 comprising:
wherein the wind turbine is in the raised position;
the wind turbine being positioned atop a free end of the base structure; and
the counterweight being positioned adjacent to the free end of the base structure.

10. The pivoting wind turbine tower assembly as claimed in claim 1 comprising:
the at least one wind turbine being a first turbine and a second turbine;
the at least one base structure being a first base;
the first turbine and the second turbine being oppositely positioned of each other about the first base; and
the first turbine and the second turbine being mounted to the first base by the lifting mechanism.

11. The pivoting wind turbine tower assembly as claimed in claim 1 comprising:
the at least one wind turbine being a first turbine;
the at least one base structure being a first base and a second base;
the first base and the second base being oppositely positioned of each other about the first turbine; and
the first turbine being mounted to the first base and the second base by the lifting mechanism.

12. A pivoting wind turbine tower assembly comprising:
at least one wind turbine;
at least one base structure;
at least one lifting mechanism;
a rotary adjustment mechanism;
the lifting mechanism comprising a mounting shaft, a pivoting arm, a counterweight, a winch, and a cable;
the mounting shaft being outwardly connected to the base structure;
the pivoting arm being rotatably mounted to the mounting shaft;
the wind turbine being mounted onto a first end of the pivoting arm by the rotary adjustment mechanism;
the counterweight being mounted onto a second end of the pivoting arm;
the winch being mounted offset to the counterweight; and
the cable being tensionably connected between the counterweight and the winch, wherein the rotational direction of the winch moves the wind turbine between a lowered position and a raised position about the mounting shaft.

13. The pivoting wind turbine tower assembly as claimed in claim 12 comprising:
the base structure comprising a fixed end and a free end;
the fixed end and the free end being oppositely positioned of each other;
the mounting shaft being positioned adjacent to the free end;
the second end of the pivoting arm being positioned adjacent to the free end;
the winch being positioned adjacent to the fixed end of the base structure; and
the winch being positioned offset from the mounting shaft.

14. The pivoting wind turbine tower assembly as claimed in claim 12 comprising:
the wind turbine comprising a nacelle, a gearbox, a generator, a main shaft, a hub, a plurality of blades, a yaw drive unit, and a yaw drive extension;
the gearbox, the generator, and the main shaft being positioned within the nacelle;
the hub being externally positioned to the nacelle;
a stator of the generator being mounted to the nacelle;
the gearbox being mounted to the nacelle;
a rotor of the generator being rotatably connected to the main shaft through the gearbox;
the hub being axially connected to the main shaft;
each of the plurality of blades being radially connected to the hub;
the nacelle being mounted to the first end of the pivoting arm by the yaw drive unit and the yaw drive extension;
the yaw drive extension being operatively coupled with the yaw drive unit, wherein rotational movement of the yaw drive unit is transferred to the yaw drive extension;
the yaw drive unit being mounted to the first end of the pivoting arm; and
the nacelle being operatively coupled with the yaw drive extension by the rotary adjustment mechanism, wherein the rotary adjustment mechanism changes the annular positioning of the nacelle in relation to the pivoting arm.

15. The pivoting wind turbine tower assembly as claimed in claim 12, wherein the rotary adjustment mechanism rotates the nacelle 0 to 90 degrees.

16. The pivoting wind turbine tower assembly as claimed in claim 12 comprising:
at least one locking mechanism;
the locking mechanism comprising a support, an actuator, and a locking body;
the support being laterally mounted to the base structure;
the actuator being integrated into the support;
the locking body being connected to the actuator; and
the locking body being selectively engaged with the pivoting arm.

17. The pivoting wind turbine tower assembly as claimed in claim 12 comprising:
wherein the wind turbine is in the lowered position;
the counterweight being positioned atop a free end of the base structure; and
the wind turbine being positioned adjacent to a fixed end of the base structure.

18. The pivoting wind turbine tower assembly as claimed in claim 12 comprising:
wherein the wind turbine is in the raised position;
the wind turbine being positioned atop a free end of the base structure; and
the counterweight being positioned adjacent to the free end of the base structure.

19. The pivoting wind turbine tower assembly as claimed in claim 12 comprising:
the at least one wind turbine being a first turbine and a second turbine;
the at least one base structure being a first base;
the first turbine and the second turbine being oppositely positioned of each other about the first base; and
the first turbine and the second turbine being mounted to the first base by the lifting mechanism.

20. The pivoting wind turbine tower assembly as claimed in claim 12 comprising:
the at least one wind turbine being a first turbine;
the at least one base structure being a first base and a second base;
the first base and the second base being oppositely positioned of each other about the first turbine; and
the first turbine being mounted to the first base and the second base by the lifting mechanism.
